(19) United States
(12) Patent Application Publication
(10) Pub. No.: US 2018/0029173 A1
(43) Pub. Date: Feb. 1, 2018

(54) METHOD FOR REPAIRING THE TEETH OF A RING GEAR

(71) Applicant: FIVES FCB, Villeneuve D'ascq (FR)

(72) Inventors: Herve CORDIER, Villeneuve D'ascq (FR); Alain CORDONNIER, Villeneuve D'ascq (FR); Maxime RAMAEL, Villeneuve D'ascq (FR)

(73) Assignee: FIVES FCB, Villeneuve D'ascq (FR)

(21) Appl. No.: 15/551,717

(22) PCT Filed: Jun. 11, 2015
(86) PCT No.: PCT/FR2015/051548

§ 371 Date: Aug. 17, 2017

(30) Foreign Application Priority Data
Mar. 17, 2015 (FR) 15 52195

(51) Int. Cl. B23P 6/00

(52) U.S. Cl. CPC B23P 6/00; B23F 17/00

(57) ABSTRACT

Method for repairing the teeth of a ring gear and a machining device unit including a frame and a moving part bearing a cutting member movable along multiple axes with respect to the frame, the method including: attaching the machining device to the ring gear by tightening parts rigidly attached to the frame of the machining device, engaging with the flanks of the ring gear, defining the position of the machining device with respect to the tooth to be machined by abutting on the flank of a reference tooth, the flank being situated, with respect to the summit of the reference tooth, in the direction opposite the flank of the tooth to be machined, the reference tooth being the tooth to be machined or an immediately preceding tooth, performing the machining of the flank of the tooth to be machined by control of the cutting member per predetermined machining operations.

The invention relates to a method for repairing the teeth of a ring gear by means of a machining device, as well as to a machining device as such, suitable for implementing the method.

The field of the invention is that of large-scale rotating machines, often having a substantially horizontal axis, such as those used in the chemical, mineral or sugar industries, equipped with a large-scale ring gear driving the rotating machines in rotation via a pinion and motor assembly. Rotating machines of this type include rotary furnaces, ball mills, horizontal pebble mills and sugar diffusion systems, etc.

With such machines, the repeated contact between the teeth of the pinion and of the ring gear is a source of wear, which can take on various characteristics as a result of the relative position configuration between the drive system comprising the pinion and the driven machine, and the various movements of the machine aside from the rotation about the axis. The form of the teeth strays from the original profile, which was of the epicycloid type, the thickness thereof is reduced and isolated surface defects can appear.

When the contact surfaces stray from the ideal profile, the forces that are exerted on the teeth can take on abnormal directions and vibrations can appear. This induces abnormal mechanical forces applied on the attachment of the ring gear, the motor assembly and the machine itself and the supports thereof, which can cause damage to the various mechanical systems, and further amplify tooth wear phenomena.

When the level of wear becomes high, the toothed ring gear must be repaired or replaced. The replacement operation is long and expensive for large-scale machines. Given that the rotating machine and the toothed ring gear only rotate in a single direction, the contact of the pinion on the ring gear only occurs on one of the two flanks of each tooth of the ring gear. One alternative sometimes involves turning over the ring gear, with the aim of exposing the other tooth flanks that have not suffered wear. However, this turning operation is still fastidious, although a little less expensive. In general, a repair can be made to restore a high-quality shape of the contact surfaces that is compatible with good mechanical operation; said restoration can be made at least once before the ring gear must be turned over or replaced.

Such a repair takes place without dismantling the ring gear; only the protective parts are removed to provide access to the teeth. This consists in a machining operation, generally by grinding, to recreate a shape suitable for engagement on one side of each tooth of the ring gear.

Tooth surface repair operations are currently performed manually by operators using machining or grinding tools. The operational outcome is assessed for each tooth by comparison with a template constituting the reference shape.

In the applicant's experience, the final outcome greatly depends on the know-how and experience of the operator.

The purpose of this invention is to propose a method for repairing the teeth of a ring gear, designed for the ring gears of large-scale machines, which does not require the dismantling of the ring gear, and the automation level of which allows the performance quality to be reproduced.

The invention can in particular be applied for the machining of ring gears, the diameter of which is greater than or equal to 1.5 metres.

Another purpose of this invention is to propose such a method, in which the positioning of the machining device on the ring gear is both fast and simple.

Other purposes and advantages of the invention will appear when reading the following description, which is given for the purpose of illustration only and is not intended to limit the scope of the invention.

The invention relates to a method for repairing the teeth of a ring gear by means of a machining device comprising a frame and a moving part bearing a cutting member that can be moved along a plurality of axes with respect to the frame, said method being implemented in-situ without dismantling the ring gear from the support thereof.

Said method comprises the following steps for implementing the machining operation for a tooth:

attaching said machining device to the ring gear by the action of tightening parts rigidly attached to the frame of the machining device, engaging with the flanks of the ring gear,

defining the position of said machining device with respect to the tooth to be machined by bearing on the flank of a reference tooth, the flank being situated, with respect to the crest of the reference tooth, facing the opposite direction to the flank of the tooth to be machined, the reference tooth being the tooth to be machined or an immediately preceding tooth,

performing the machining of the flank of the tooth to be machined in an automated manner by control of the cutting member according to predetermined machining operations recorded, in digital form, in a memory.

According to the optional characteristics of the method according to the invention, which can be implemented alone or in any combination:

said step for defining the position of said machining device with respect to the tooth to be machined implements at least one first lower bearing and one second upper bearing, the positions of which are offset in height along the flank of the reference tooth;

the first lower bearing on the flank of the reference tooth is produced by a bearing member simultaneously bearing against the base of the reference tooth;

the reference tooth is the tooth to be machined;

the machining operations involve planing by implementing an alternating movement of the cutting member;

the frame is attached to and locked in place on the ring gear solely by the action of tightening parts on the flanks of the ring gear;

the predetermined machining operations reproduce a tooth profile of an epicyclic toothing.

The invention further comprises equipment comprising a machining device, intended to machine a toothed ring gear, suitable for in-situ machining, without dismantling the toothed ring gear, said machining device comprising a frame and a moving part bearing a cutting member that can be moved along a plurality of axes, said device comprising:

tightening parts, rigidly attached to the frame, capable of extending on either side of the ring gear, capable of moving with respect to the frame, and suitable for attaching and locking the frame by tightening of the flanks of the ring gear,

bearing means for bearing on the flank of a reference tooth, situated, with respect to the crest of the reference tooth, facing the opposite direction to the flank of the tooth to be machined, the reference tooth being the tooth to be machined or an immediately preceding tooth,

and wherein said equipment comprises instrumentation and control means capable of automatically controlling the cutting member in order to machine the tooth according to a determined profile, comprising a memory in which the machining operations of the tooth according to said determined profile are recorded in digital form.

According to the optional characteristics of the device according to the invention, which can be implemented alone or in any combination:

the bearing means for bearing on the flank of the reference tooth comprise a first bearing member and a second bearing member, intended to respectively produce a first lower bearing and a second upper bearing, the positions of which are offset in height over the flank of the tooth;

the first lower bearing is arranged so as to simultaneously bear against the base of the tooth;

said bearing means for bearing on the flank of a reference tooth are arranged with respect to the frame and to the cutting member so as to engage with the tooth to be machined.

The invention will be better understood upon reading the following description, which is given for the purposes of illustration only, with reference to the accompanying figures, wherein:

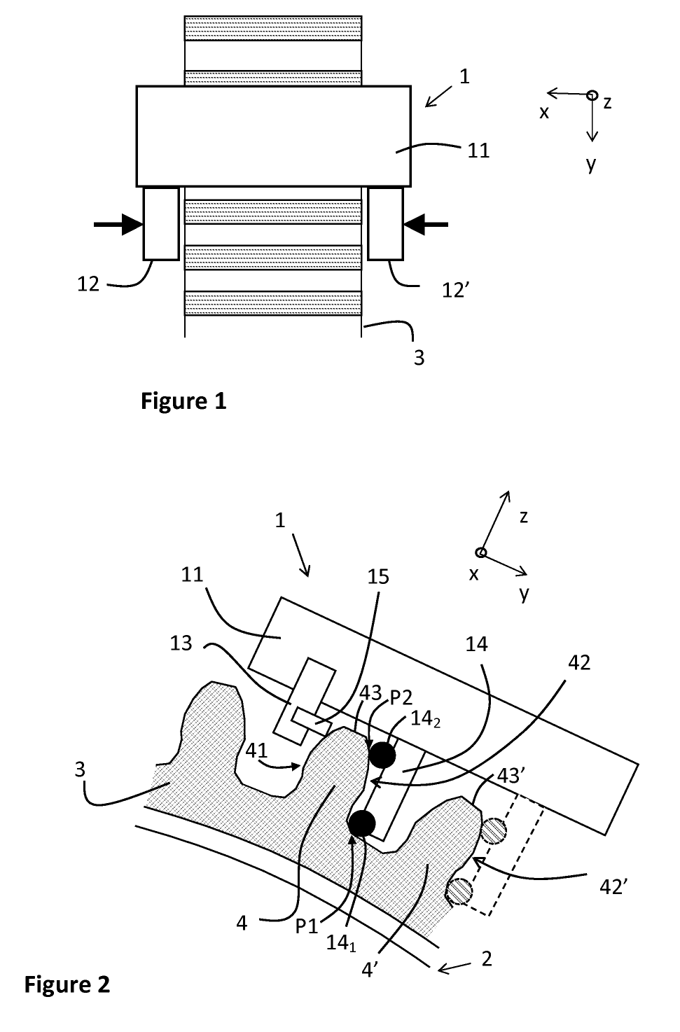

FIG. 1 is a diagrammatic overhead view of a ring gear on which the machining device is fixed by tightening of the flanks of the ring gear,

FIG. 2 is a diagrammatic side view showing the position of the device bearing on the flank of a reference tooth.

The invention relates to a method for repairing the tooth of a ring gear 3 by means of a removable machining device 1.

This device comprises a frame 11 and a moving part 13 bearing a cutting member 15 that can be moved along a plurality of axes with respect to the frame 11, which is potentially orientable. The tooth profile to be reproduced can be that of an epicyclic toothing comprising epicyclic sections.

Advantageously, said method according to the invention is implemented in-situ, i.e. without dismantling the ring gear from its support, in particular without dismantling the ring gear from the ferrule of the rotating machine, which can in particular be a rotary furnace, a dryer, a sugar diffusion system, a pebble mill or a ball mill.

Said method comprises the following steps for implementing the machining operation for a tooth 4:

attaching said machining device 1 to the ring gear 3 by the action of tightening parts 12, 12′ rigidly attached to the frame of the machining device, engaging with the flanks of the ring gear 3,

defining the position of said machining device 1 with respect to the tooth to be machined 4 by bearing on the flank 42; 42′ of a reference tooth, the flank 42, 42′ being situated, with respect to the crest 43; 43′ of the reference tooth, facing the opposite direction to the flank 41 of the tooth to be machined 4, the reference tooth being the tooth to be machined 4 or an immediately preceding tooth 4′,

performing the machining of the flank 41 of the tooth to be machined 4 by control of the cutting member 15 according to predetermined machining operations.

The tightening parts 12, 12′ can be moved on the frame 11, and can be moved closer to each other, along a direction that is perpendicular to the plane of the ring gear, in order to tighten the two flanks of the ring gear, by any suitable system such as a screw-nut bolt system, hydraulic actuator or other mechanism. These tightening parts 12, 12′ can also, through the bearings created on the flanks of the ring gear, be used to define the position of the device along a direction that is perpendicular to the plane of the ring gear, i.e. the direction OX referenced in the figures.

According to one advantageous embodiment, the frame 11 is attached to and locked in place on the ring gear 3 solely by the action of tightening the parts 12, 12′ on the flanks of the ring gear 3, and the friction between said parts 12, 12′ and the flanks of the ring gear. In such a case, no additional step is required to ensure the attachment and locking of the device. Such attachment simplicity is sought after herein in that, and in order to repair all teeth of the ring gear, the device must be moved many times in different attachment positions respectively associated with the repair of the different teeth of the ring gear. The manner in which the machining device can be moved on the ring gear, allowing all teeth to be repaired, is described in an international patent application PCT filed on the same day by the Applicant, as well as in the French patent application FR 15 52197 of 17 Mar. 2015; the content of said applications is stipulated herein for reference purposes.

The step for defining the position of said machining device 1 with respect to the tooth to be machined 4 is obtained by bearing on the flank 42; 42′ of a reference tooth. Said flank 42, 42′ is situated, with respect to the crest 43; 43′ of the reference tooth, facing the opposite direction to the flank 41 of the tooth to be machined 4. Given that the method of repair is mainly intended for toothed ring gears mounted on rotating machines driven in a single direction of rotation, the flank of the reference tooth on which the bearing is made is advantageously a flank that has not suffered wear. The reference tooth can be the tooth to be machined 4 or an immediately preceding tooth 4′, as shown in FIG. 2.

According to one embodiment, this step can implement a first lower bearing P1, and a second upper bearing P2, the positions of which are offset in height over the flank 42; 42′ of the reference tooth 4; 4′.

For this purpose, the machining device comprises bearing means 14 for bearing on the flank of the reference tooth 4; 4′ that can comprise at least one first bearing member 14₁ and one second bearing member 14₂, separate from each other, intended to respectively produce a first lower bearing P1 and a second upper bearing P2, the positions of which are offset in height over the flank of the tooth.

According to one embodiment, the first lower bearing P1 on the flank 42; 42′ of the reference tooth is produced by a bearing member, in this instance said first bearing member 14₁, simultaneously bearing against the base of the reference tooth 4; 4′.

In general, the step for defining the device by bearing on the flank of the reference tooth is used to determine the position of the device in a plane parallel to the plane of the ring gear, i.e. the OYZ plane referenced in the figures.

According to one embodiment, the sole positioning and attachment bearings of the device with the toothed ring gear are constituted from the bearings of the tightening parts 12, 12′ on the flanks of the toothed ring gear in order to guarantee the attachment of the device, and from the one or more bearings of the bearing means 14 on the flank of the reference tooth, facing the opposite direction to the flank of the tooth to be machined 4.

According to one embodiment, the machining operation can take place by milling or by grinding. It can also take place by planing, by implementing an alternating movement of the cutting member 15.

The flank 41 of the tooth to be machined 4 is machined by control of the cutting member 15 according to predetermined machining operations. For this purpose, instrumentation and control means are capable of automatically controlling the cutting member in order to machine the tooth according to a determined profile, using various actuators.

Said instrumentation and control means can comprise a memory in which machining operations for the tooth according to said determined profile are recorded in digital form. Said digital machining instructions are created for each ring gear before the start of the machining operation, depending on the dimensions of the ring gear, the toothing module and the level of wear. It is used to reproduce a perfectly identical profile for each tooth in an automated manner. Once the tooth to be machined 4 has been cut, the frame of the device is loosened, moved one step, and secured again to the ring gear with the aim of cutting the next tooth of the ring gear.

The degrees of freedom of the cutting tool allow the tooth to be machined to be cut according to a desired tooth profile, and in particular an epicyclic tooth profile. For this purpose, the moving part 13 can be moved along a plurality of axes, in particular along the OX axis, i.e. transversally to the ring gear 3, along the OY axis, i.e. in a direction parallel to the plane of the ring gear and perpendicular to the radial direction passing through the tooth to be machined 4, and along the OZ direction, i.e. substantially in the radial direction passing through the tooth to be machined 4. The cutting member 15 can also be oriented in relation to the moving part, for example along a rotational axis parallel to the OX axis.

Other embodiments could clearly have been considered without exiting the scope of the invention as defined by the claims herein below.

### PARTS LIST

1. Machining device,
2. Support (for example a rotating machine),
3. Toothed ring gear,
4. Tooth to be machined,
4′. Reference tooth (if different to the tooth to be machined),
11. Frame,
12. 12′. Tightening parts,
13. Moving part, for example a trolley,
14. Bearing means for bearing on the reference tooth,
15. Cutting member,
41. Flank of the tooth to be machined,
42. Flank of the reference tooth, belonging to the tooth to be machined, facing in the opposite direction to the flank to be machined,
42′. Flank of the reference tooth, facing in the opposite direction to the flank to be machined, constituted from a tooth preceding the tooth to be machined,
43. Crest of the tooth to be machined,
43′. Crest of the reference tooth constituted from a tooth preceding the tooth to be machined,
P1. First lower bearing,
P2. Second upper bearing.

1. Method for repairing the teeth of a ring gear (3) by means of a machining device (1) comprising a frame (11) and a moving part (13) bearing a cutting member (15) that can be moved along a plurality of axes with respect to the frame (11), said method being implemented in-situ without dismantling the ring gear from the support (2) thereof, said method comprising the following steps for implementing the machining of a tooth (4):
attaching said machining device (1) to the ring gear (3) by the action of tightening parts (12, 12′) rigidly attached to the frame of the machining device, engaging with the flanks of the ring gear (3),
defining the position of said machining device (1) with respect to the tooth to be machined (4) by bearing on the flank (42; 42′) of a reference tooth, the flank (42, 42′) being situated, with respect to the crest (43; 43′) of the reference tooth, facing the opposite direction to the flank (41) of the tooth to be machined (4), the reference tooth being the tooth to be machined (4) or an immediately preceding tooth (4′),
performing the machining of the flank (41) of the tooth to be machined (4) in an automated manner by control of the cutting member (15) according to predetermined machining operations recorded, in digital form, in a memory.

2. Method according to claim 1, wherein said step for defining the position of said machining device with respect to the tooth to be machined (4) implements a first lower bearing (P1) and a second upper bearing (P2), the positions of which are offset in height along the flank (42; 42′) of the reference tooth (4; 4′).

3. Method according to claim 2, wherein the first lower bearing (P1) on the flank (42; 42′) of the reference tooth is produced by a bearing member (14₁) simultaneously bearing against the base of the reference tooth (4; 4′).

4. Method according to claim 1, wherein the reference tooth is the tooth to be machined (4).

5. Method according to claim 1, wherein the machining operations involve planing by implementing an alternating movement of the cutting member (15).

6. Method according to claim 1, wherein the frame (11) is attached to and locked in place on the ring gear (3) solely by the action of tightening parts (12, 12′) on the flanks of the ring gear (3).

7. Method according to claim 1, wherein the predetermined machining operations reproduce a tooth profile of an epicyclic toothing.

8. Equipment comprising a machining device (1), intended to machine a toothed ring gear (3), suitable for in-situ machining, without dismantling the toothed ring gear, said machining device (1) comprising a frame (11) and a moving part (13) bearing a cutting member (15) that can be moved along a plurality of axes, said device comprising:
tightening parts (12, 12′), rigidly attached to the frame (11), capable of extending on either side of the ring gear (3), capable of moving with respect to the frame, and suitable for attaching and locking the frame by tightening of the flanks of the ring gear (3),
bearing means (14) for bearing on the flank of a reference tooth, situated, with respect to the crest (43; 43′) of the reference tooth, facing the opposite direction to the flank (41) of the tooth to be machined (4), the reference tooth being the tooth to be machined (4) or an immediately preceding or subsequent tooth (4′),
and wherein said equipment comprises instrumentation and control means capable of automatically controlling the cutting member in order to machine the tooth according to a determined profile, comprising a memory in which the machining operations of the tooth according to said determined profile are recorded in digital form.

9. Equipment according to claim 8, wherein the bearing means (14) for bearing on the flank of the reference tooth (4; 4′) comprise a first bearing member (14₁) and a second bearing member (14₂), intended to respectively produce a first lower bearing (P1) and a second upper bearing (P2), the positions of which are offset in height over the flank of the tooth.

10. Equipment according to claim 9, wherein the first lower bearing (P1) is arranged so as to simultaneously bear against the base of the tooth.

11. Equipment according to claim 8, wherein said bearing means (14) for bearing on the flank of a reference tooth are arranged with respect to the frame and to the cutting member (15) so as to engage with the tooth to be machined (4).

12. Method according to claim 2, wherein the reference tooth is the tooth to be machined (4).

13. Method according to claim 3, wherein the reference tooth is the tooth to be machined (4).

14. Method according to claim 2, wherein the machining operations involve planing by implementing an alternating movement of the cutting member (15).

15. Method according to claim 3, wherein the machining operations involve planing by implementing an alternating movement of the cutting member (15).

16. Method according to claim 4, wherein the machining operations involve planing by implementing an alternating movement of the cutting member (15).

17. Method according to claim 2, wherein the frame (11) is attached to and locked in place on the ring gear (3) solely by the action of tightening parts (12, 12′) on the flanks of the ring gear (3).

18. Method according to claim 3, wherein the frame (11) is attached to and locked in place on the ring gear (3) solely by the action of tightening parts (12, 12′) on the flanks of the ring gear (3).

19. Method according to claim 4, wherein the frame (11) is attached to and locked in place on the ring gear (3) solely by the action of tightening parts (12, 12′) on the flanks of the ring gear (3).

20. Method according to claim 5, wherein the frame (11) is attached to and locked in place on the ring gear (3) solely by the action of tightening parts (12, 12′) on the flanks of the ring gear (3).
